(19) United States
(12) Patent Application Publication
(10) Pub. No.: US 2001/0031369 A1
(43) Pub. Date: Oct. 18, 2001

(54) Process for preparing radiation-curable binders, and the coatings produced therewith

(76) Inventor: Gerhard Reusmann, Essen (DE)

Correspondence Address: William F. Lawrence, Esq., c/o FROMMER LAWRENCE & HAUG LLP, 745 Fifth Avenue, New York, NY, 10151, US

(21) Appl. No.: 09/799,257

(22) Filed: Mar. 5, 2001

(30) Foreign Application Priority Data
Mar. 7, 2000 (DE) 100 10 994.2

(51) Int. Cl. B32B 27/06; C08G 18/16; C08G 69/48; C08F 283/04; B32B 27/36

(52) U.S. Cl. 428/483; 427/385.5; 525/455; 528/49; 525/421

(57) ABSTRACT

Process for preparing radiation-curable binders, and the coatings produced therewith. The present invention describes the preparation of urethane acrylate compounds on the basis of α,ω-polymethacrylatediols and their use as binders for radiation-curable coatings.

### RELATED APPLICATIONS

This application claims priority to German application 100 10 994.2, filed Mar. 7, 2000.

### BACKGROUND OF THE INVENTION

1. Field of the Invention

The present invention provides for the preparation of urethane acrylate compounds on the basis of α,ω-polymethacrylatediols and their use as binders for radiation-curable coatings.

2. Description of the Related Art

In radiation curing, binders are used which polymerize or cure rapidly under the effect of UV light or electrons. A customary radiation-curing coating material consists in principle of a reactive resin, one or more monomers, and, if desired, fillers, flatting agents and/or pigments, plus one or more additives if necessary. With the UV technology, polymerization is usually initiated using photoinitiators or photosensitizers.

The selection of binder depends on a number of factors: in particular on the substrate, on the required film properties, for example, hardness, scratch resistance, flexibility, and adhesion, and on the method of application. An overview of customary binder systems for radiation-curing coating materials is given, for example, by N. S. Allen et al. in UV and EB Curable Polymers, chapter II, Vol. 2, “Chemistry & Technology of UV & EB Formulation for Coatings, Inks and Paint”, SITA Technology 1991.

Examples of resins which, as unsaturated compounds containing reactive groups, lead polyesters, urethanes, polyacrylates, epoxy resins, oligoether acrylates, and unsaturated polyester/styrene binders.

Urethane acrylates are used especially for the overcoating of PVC and cork flooring, owing to their high abrasion resistance and flexibility. Further examples of applications are wood coatings, overprint varnishes, printing inks, and leather coatings. Additionally, urethane acrylates are used in coating systems for flexible plastics substrates. In the electrical industry, urethane acrylates are used in screen printing inks and solder resists for printed circuit boards. Moreover, urethane acrylates usually have Draize values of less than 1 (see also P. G. Garrat in “Die Technologie des Beschichtens—Strahlenhärtung” [The technology of coating —radiation curing], Vincentz Verlag, Hannover, 1996).

There are a number of representatives of the urethane acrylate compounds which may be prepared from a large number of starting materials. Acrylated urethanes are formed in principle by reacting an isocyanate group with a hydroxyl-containing acrylate or methacrylate monomer. When diisocyanates are employed, the corresponding divinyl adducts are obtained. An overview of the composition of radiation-curing coating materials and formulations is given by P. G. Garrat (loc. cit.). The simplest urethane acrylates are obtained by reacting a diisocyanate with a hydroxyl-containing monomer. If further hydroxyl-containing compounds are used, such as polyols, polyesters or polyethers having more than one hydroxyl group, for example, chain extension takes place. Commercially available diisocyanates which may be acrylated include tolylene diisocyanate (TDI), hexamethylene diisocyanate (HMDI), isophorone diisocyanate (IPDI), and tetramethylxylene diisocyanate (TMXDI). Also available are oligomers of some of these products, for example, of HMDI. The acrylic monomers with hydroxyl functionality that are employed in practice are, in particular, hydroxyethyl acrylate (HEA) and hydroxypropyl acrylate (HPA).

A large number of urethane acrylates may be prepared by using starting materials having two or more hydroxyl groups. Flexible urethane acrylates are obtained, for example, by reacting a diisocyanate with a long-chain glycol and a hydroxyl-containing monomer. A more or less hard urethane acrylate is formed by reacting a more or less highly branched polyfunctional polyol with a diisocyanate and a hydroxyl-containing monomer.

In principle, there are two possible preparation pathways. In one, a hydroxyl-containing precondensate or addition polymer may be reacted with an excess of diisocyanate. The unsaturated urethane acrylate is formed by hydroxyalkyl acrylate addition. Alternatively, the diisocyanate and hydroxyalkyl acrylate may be reacted first, after which the semiadduct is reacted with a hydroxyl-containing polycondensate or addition polymer.

There are known to be three main classes of urethane acrylates: the polyester urethane acrylates (prepared from polyesterpolyols), the polyether urethane acrylates (prepared from polyetherpolyols), and polyol urethane acrylates.

Urethane acrylate compounds having very different properties are available commercially. Coatings based on urethane acrylate are notable in particular for high toughness, chemical resistance, and adhesion. Modifications to the polymer framework, in terms of chain length, concentration of reactive groups and other functional parameters, for example, influence the properties of the products in different respects. Light-stable urethane acrylates are formed by the use of the aliphatic diisocyanates such as IPDI or HMDI. The use of inexpensive aromatic diisocyanates may lead to light stability problems and discoloration problems.

### SUMMARY OF THE INVENTION

The present invention provides for the preparation of urethane acrylates on the basis of α,ω-polymethacrylatediols and their use as binders for radiation-curable coatings.

In accordance with EP-A-0 386 507, herein incorporated by reference, α,ω-polymethacrylatediols may be prepared by selectively transesterifying ω-hydroxy-functional polymethacrylates with short-chain diols. An overview of the preparation is given by A. Knebelkamp and G. Reusmann “α,ω-Polymethacrylatdiole in PUR-Bindemitteln” [α,ω-Polymethacrylatediols in PU binders] in Farbe & Lack 105, 1999, p. 24. α,ω-Polymethacrylatediols are available commercially from Tego Chemie Service GmbH (DE) under the trade names TEGO® Diol BD 1000 (α,ω-polybutyl methacrylate diol having a molecular mass of 1000 g/mol) or TEGO® Diol MD 1000 (α,ω-polymethyl methacrylate diol having a molecular mass of 1000 g/mol).

It has surprisingly now been found that by using this class of macrodiols, the α,ω-polymethacrylatediols, new kinds of properties are found in the radiation-curable coatings formulated from them.

### DETAILED DESCRIPTION OF THE INVENTION

The present invention relates in a first embodiment to urethane acrylates obtainable by reacting

a) αω-polymethacrylatediols, mixtures thereof or mixtures of polyols with α,ω-polymethacrylatediols with

b) one or more polyisocyanates containing in each case at least two isocyanate groups and

c) one or more hydroxyalkyl acrylates or hydroxyalkyl methacrylates in the presence of

d) inhibitors and, if desired,

e) isocyanate-reactive compounds.

It has surprisingly been found that by using urethane acrylates based on α,ω-polymethacrylatediols it is possible to achieve particular coating properties. In particular, the use of the urethane acrylate binders of the invention permits the formulation of particularly hard and flexible coatings. Accordingly, such coatings have particularly good scratch resistances in comparison to conventional, prior art coatings based on polyesterpolyols or polyetherpolyols. There is also a decisive improvement in the weathering stability.

The α,ω-polymethacrylatediols used are preparable in accordance with EP-A-0 386 507, herein incorporated by reference, by selective transesterification of α,ω-hydroxy-functional polymethacrylates with short-chain diols. The molecular mass (for example 1000 g/mol, 2000 g/mol), may be controlled by varying the amount of the hydroxyl-containing chain transfer agent used—mercaptoethanol, for example; the glass transition temperature (Tg) (for example, Tg=20° C., Tg=−30° C.) may be controlled by varying the methacrylate monomer—methyl methacrylate or butyl methacrylate, for example. Examples of particularly suitable α,ω-polymethacrylatediols are TEGO® Diol BD 1000 (α,ω-polybutylmethacrylatediol having a molecular mass of 1000 g/mol) and TEGO® Diol MD 1000 (α,ω-polymethylmethacrylatediol having a molecular mass of 1000 g/mol).

It is of course also possible to use mixtures of different α,ω-polymethacrylatediols or mixtures of α,ω-polymethacrylatediols with other polyols, examples being polyesterpolyols, polycarbonatediols or polyetherpolyols. To prepare water-dilutable urethane acrylates, mixtures with emulsifying polyols, such as dimethylolpropionic acid, for example, may be used.

Suitable polyisocyanates possess at least two isocyanate functions per molecule. Examples of polyisocyanates are, in particular, diisocyanates and triisocyanates. Suitable diisocyanates include, for example, tolylene diisocyanate (TDI), hexamethylene diisocyanate (HMDI), isophorone diisocyanate (IPDI), diphenylmethane diisocyanate (MDI), and tetramethylxylene diisocyanate (TMXDI). Oligomers of some of these products are also available, for example, an oligomer of HMDI (trimer).

The use of aliphatic diisocyanates such as IPDI or HMDI produces particularly light-stable and discoloration-resistant urethane acrylates.

Suitable acrylic monomers with hydroxyl functionality are, in particular, hydroxyalkyl acrylates such as hydroxyethyl acrylate (HEA) and hydroxypropyl acrylate (HPA), for example. It is likewise possible to use the corresponding, less toxic hydroxyalkyl methacrylates.

An important constituent of the reaction mixtures for preparing the urethane acrylates of the invention is the presence of inhibitors. For the purposes of the present invention, inhibitors include, in particular, stabilizers for (meth)acrylic acid or (meth)acrylates. Examples of suitable stabilizers are hydroquinone monomethyl ether, optionally hydroquinone or phenothiazine as well, which may be used in amounts which are customary for the stabilization of (meth)acrylic acid or (meth)acrylates. The function of these inhibitors is to prevent the homopolymerization of the hydroxyalkyl acrylates or else of the isocyanate-functional acrylates or methacrylates which, as component b or b′, respectively, constitute an essential constituent of the urethane acrylates of the invention.

The molar ratio of α,ω-polymethacrylatediol to diisocyanate to hydroxyalkyl acrylate may be varied within wide ranges. Urethane acrylates which are particularly suitable for use are obtained, however, using an approximately stoichiometric ratio of the components to one another. For the purposes of the present invention, accordingly, it is particularly preferred to set the molar ratio of α,ω-polymethacrylatediol to diisocyanate to hydroxyalkylacrylate in the region of about 1:2:2.

Where the polyisocyanate used comprises a triisocyanate, it is particularly preferred in the same sense to set the molar ratio of α,ω-polymethacrylatediol to triisocyanate to hydroxyalkyl acrylate in the region of about 1:2:4.

In the case of the reaction of α,ω-polymethacrylatediols with an isocyanate-functional acrylate or methacrylate, it is also possible to vary the molar ratio of these two components within broad ranges. For the purposes of the present invention, particular preference is given to a stoichiometric ratio of the components to one another. Thus, in accordance with the invention, it is preferred to set the molar ratio of α,ω-methacrylatediol to isocyanate-functional (meth)acrylate in the region of about 1:1.

A general rule for the urethane acrylates of the invention is that the polyols used in combination with the α,ω-polymethacrylatediols may also be varied in a wide selection. Accordingly, suitable polyols for the purposes of the present invention include, in particular, polyesterpolyols, polyetherpolyols, polycarbonatediols, or monomeric polyols.

Urethane hexaacrylates in the sense of the present invention may be obtained by reacting hydroxy-functional triacrylates, an example being pentaerythritol triacrylate (PETA). In coatings, corresponding binders have particularly high crosslinking densities.

The preparation takes place in accordance with the following reaction scheme:

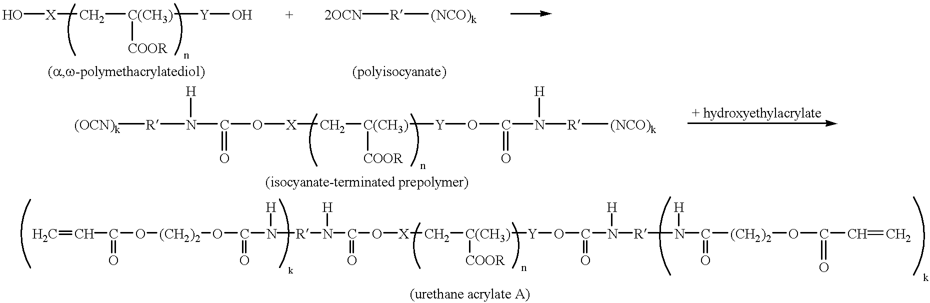

Preferably, n is from 2 to 1000 and k is from 1 to 5, R is alkyl, preferably containing 1 to 20 carbon atoms, and R′ is an alkyl group, preferably containing 1 to 20 carbon atoms, an aromatic group, preferably containing 6 to 20 carbon atoms, an adduct or condensate of isocyanates (for example uretdione, isocyanurate, iminooxadiazinedione, biuret) or else of isocyanates with alcohols (for example, urethane or allophanate). An overview of various isocyanates and their preparation is given by M. Bock in “Polyurethane für Lacke und Beschichtungen” [Polyurethanes for paints and coatings] (Vincentz-Verlag Hannover, 1999). Here, X and Y are preferred radicals, whose definition is given in A. Knebelkamp and G. Reusmann (loc. cit.).

The corresponding reaction in the second reaction step with diacrylates, such as trimethylolpropane diacrylate, produces a urethane tetraacrylate. Urethane hexaacrylates may be synthesized by reaction, for example, with pentaerythritol triacrylate.

For the purposes of the present invention, therefore, the process for preparing urethane acrylates of the present invention comprises reacting

a) α,ω-polymethacrylatediols, mixtures thereof or mixtures of polyols and α,ω-polymethacrylatediols with

b) one or more polyisocyanates containing in each case at least two isocyanate groups and

c) one or more hydroxyalkyl acrylates or hydroxyalkyl methacrylates in the presence of

d) inhibitors and, if desired,

e) isocyanate-reactive compounds.

An alternative reaction pathway is the reaction of an α,ω-polymethacrylatediol with 2 equivalents of an isocyanate-functional acrylate or methacrylate, such as isocyanatoethyl methacrylate (where R″ is alkyl, preferably containing of 1 to 8 carbon atoms and R and n are defined above).

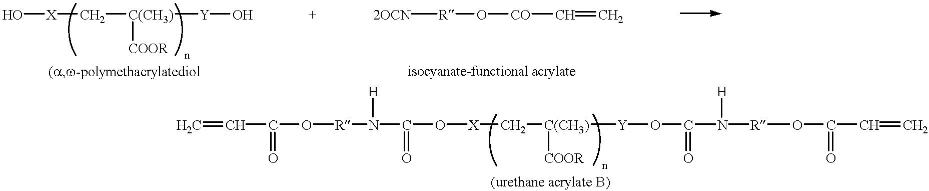

Accordingly, a further embodiment of the present invention is a process for preparing urethane acrylates which comprises reacting

a) α,ω-polymethacrylatediols, mixtures thereof or mixtures of polyols and α,ω-polymethacrylatediols with

b) one or more isocyanate-functional acrylates or methacrylates in the presence of

d) inhibitors and, if desired,

e) isocyanate-reactive compounds.

For the purposes of the present invention it is particularly preferred subsequently to emulsify the above-defined urethane acrylate in water using one or more commercially customary emulsifiers. The amount of the emulsifier is guided by the intended application desired and may be readily determined by the skilled worker by means of simple tests.

A further embodiment of the present invention consists in particular in the use of the above-defined urethane acrylates to coat substrates. In this context it may be of particular advantage to use at least one additive from the group of monomers selected from monofunctional and polyfunctional acrylates, photoinitiators or photosentisizers, oligomers, fillers, flatting agents, thickeners, reactive diluents, pigments, solvents, light stabilizers or additives.

To examine the performance properties, the binders obtained were formulated to coating materials and tested. The binders are synthesized in accordance with the following preparation procedures.

Isocyanate-reactive compounds are used in the sense of the present invention when the resulting urethane acrylate still contains free isocyanate groups. Mention may be made in particular of methanol at this point.

In general, it is also possible to use combinations of different urethane acrylate resins or combinations with other radiation-curable binders. Specific examples include, for example, polyester acrylates or epoxy acrylates.

To formulate aqueous radiation-curable coating materials, the urethane binder of the invention is emulsified in water using one or more commercially customary emulsifiers, at a solid of 50%, for example.

### WORKING EXAMPLES

Binder: Urethane acrylate oligomer I:

444 g of isophorone diisocyanate (2 mol) were heated to 50° C. under a nitrogen atmosphere. Subsequently, 232 g of 2-hydroxyethyl acrylate (2 mol) and 70 ppm of phenothiazine (based on the total weight of urethane acrylate binder) were added dropwise over a period of 2 hours at 60° C. After the end of the reaction, the mixture was stirred at 60° C. for 3 hours and cooled to 50° C. 100 g of the α,ω-polybutyl methacrylate diol TEGO® Diol BD 1000 (1 mol) were added dropwise over a period of one hour at 60° C. The mixture was stirred at 70° C. for 3 hours, after which it was cooled to 60° C. and 0.5% of methanol (based on the total weight of urethane acrylate binder) was added in order to consume remaining isocyanate groups. The resulting product had a theoretical molecular mass of 1628 g/mol and, if required, could be diluted with reactive monomers in order to achieve a lower viscosity.

### Comparative Example 1

Binder: Urethane acrylate oligomer II (noninventive reference):

444 g of isophorone diisocyanate (2 mol) were heated to 50° C. under a nitrogen atmosphere. Subsequently, 232 g of 2-hydroxyethyl acrylate (2 mol) and 70 ppm of phenothiazine (based on the total weight of urethane acrylate binder) were added dropwise over a period of 2 hours at 60° C. After the end of the reaction, the mixture was stirred at 60° C. for 3 hours and cooled to 50° C. 105 g of the polyoxypropylene glycol from ARCOL Chemical, ARCOL 1010 (1 mol) were added dropwise over a period of one hour at 60° C. The mixture was stirred at 70° C. for 3 hours, after which it was cooled to 60° C. and 0.5% of methanol (based on the total weight of urethane acrylate binder) was added in order to consume remaining isocyanate groups. The resulting product had a theoretical molecular mass of 1678 g/mol and, if required, could be diluted with reactive monomers in order to achieve a lower viscosity.

### Comparative Example 2

Binder: Urethane acrylate oligomer III (noninventive reference):

Preparation of the polyester P1: 7.9 g of 1,3-butylene glycol (1.0 mol), 41.1 g of 1,6-hexanediol (4.0 mol), 50.9 g of adipic acid (4.0 mol) and 0.1 g dibutyltin oxide as catalyst were reacted with one another, with elimination of water, until the acid number was less than 3.0 mg KOH/g polymer. Excess water was separated off by vacuum distillation. The polyester obtained corresponded to a theoretical molecular mass of 1004 g/mol.

### Example 2

Preparation of the urethane acrylate: 444 g of isophorone diisocyanate (2 mol) were heated to 50° C. under a nitrogen atmosphere. Subsequently, 232 g of 2-hydroxyethyl acrylate (2 mol) and 70 ppm of phenothiazine (based on the total weight of urethane acrylate binder) were added dropwise over a period of 2 hours at 60° C. After the end of the reaction, the mixture was stirred at 60° C. for 3 hours and cooled to 50° C. 100 g of polyester resin P1 (1 mol) were added dropwise over a period of one hour at 60° C. The mixture was stirred at 70° C. for 3 hours, after which it was cooled to 60° C. and 0.5% of methanol (based on the total weight of urethane acrylate binder) was added in order to consume remaining isocyanate groups. The resulting product had a theoretical molecular mass of 1632 g/mol and, if required, could be diluted with reactive monomers in order to achieve a lower viscosity.

### FORMULATIONS OF THE COATINGS I TO III

The composition of the formulations tested is given in Table 1. An overview of formulations of various radiation-curable coatings is given by Skeist Incorporated in “Radiation Curing, IV—A multiple-client study” (Whippany, N.J. 07981, 1996).

TABLE 1
Formulations of the coatings (amounts in grams)

| | Formulation | Formulation | Formulation |
|---|---|---|---|
| | I | II | III |
| Urethane acrylate oligomer I | 50 | — | — |
| Urethane acrylate oligomer II | — | 50 | — |
| (reference) | | | |
| Urethane acrylate oligomer III | — | — | 50 |
| (reference) | | | |
| Multifunctional acrylates* | 42 | 42 | 42 |
| Isodecyl acrylate | 3 | 3 | 3 |
| Photoinitiator: benzophenone | 3 | 3 | 3 |
| Antirubbing additive** | 1 | 1 | 1 |
| Leveling additive*** | 0.2 | 0.2 | 0.2 |

*Mixture of trimethylolpropane triacrylate (TMPTA), tripropylene glycol diacrylate (TRPGDA), 1,6-hexanediol diacrylate (HDODA) in a weight ratio of 1:1:1
**TEGO ® Glide 100, TEGO ® Glide 410, TEGO ® Rad 2200 each usable in the same way
***TEGO ® Rad 2100

The processing viscosity was adjustable to desired levels by adding monofunctional acrylates, such as phenoxyethyl acrylate.

The coating was applied with a film thickness of 15-20 μm using a spiral-wound coating bar, and cured (instrument from Beltron, a medium-pressure mercury lamp at 120 W/cm, 2 passes at 10 m/min conveying speed). The coatings obtained were tested in accordance with the following methods.

### Test methods

Adhesion:

The adhesion test was carried out by the cross-cut test according to DIN ISO 2409.

Gloss

The gloss was measured according to DIN 67 530.

Hardness:

The pencil hardness was determined in accordance with ECCA Standard No. 14.

Flexibility:

The flexibility was determined by means of Erichsen cupping according to DIN ISO 1520 on coating films on steel panels.

Weathering and swelling tendency:

The QUV test was conducted using an instrument from QUV Company. The test took place over a period of 1500 hours with an alternating cycle of 4 hours, of irradiation and 4 hours of water condensation. The black standard temperature was 50° C. The yellowing was determined by measuring the Δ b value before and after QUV exposure, in accordance with the Hunter L a b system.

Storage stability:

In determining the storage stability after 4 weeks at 40° C., an assessment was made of the stability of the viscosity, clouding, separation phenomena, and processing properties.

The properties of the coatings tested are given in Table 2:

TABLE 2
Properties of the coatings tested

| | Formulation | Formulation | Formulation |
|---|---|---|---|
| | I | II | III |
| Coat thickness (μm) | 15 | 15 | 15 |
| Gloss (60°) | 88 | 89 | 86 |
| Hardness | 7 H | 2 H | 4-5 H |
| Flexibility (mm) | 1 | 1 to 2 | 1 |
| Adhesion (cross-cut) | Gt0 | Gt0 | Gt0 |
| Weathering (Δ b | 1.0 | 5.8 | 2.8 |
| before/after weathering) | | | |
| Swelling tendency (after | No swelling | Minimal | Severe |
| weathering) | | swelling | swelling |
| Storage stability of | Satisfactory | Satisfactory | Satisfactory |
| liquid coating | | | |

The test results clearly indicate the superiority of the coatings of the invention.

The combination of flexibility and harness in particular constitutes a unique combination of properties. The coatings of the invention thus exhibit outstanding scratch resistances and wear resistances.

The weathering stability is likewise decisively improved through the use in accordance with the invention of the α,ω-polymethacrylatediols, since in comparison with polyetherpolyol-based urethane acrylates a markedly improved UV resistance is achieved and in comparison with polyesterpolyol-based urethane acrylates a markedly improved hydrolysis resistance and swelling resistance are achieved.

The above description of the invention is inteneded to be illustrative and not limiting. Various changes or modifications in the embodiments described herein may occur to those skilled in the art. These can be made without departing from the scope and spirit of the invention.

What is claimed is:

1. A urethane acrylate obtainable by reacting
a) α,ω-polymethacrylatediols, mixtures thereof or mixtures of polyols and α,ω-polymethacrylatediols with
b) one or more polyisocyanates containing in each case at least two isocyanate groups and
c) one or more hydroxyalkyl acrylates or hydroxyalkyl methacrylates in the presence of
d) inhibitors and, optionally,
e) isocyanate-reactive compounds.

2. The urethane acrylate as claimed in claim 1, wherein the polyisocyanate is a diisocyanate.

3. The urethane acrylate as claimed in claim 2, wherein the molar ratio of α,ω-polymethacrylatediol to diisocyanate to hydroxyalkyl acrylate is about 1:2:2.

4. The urethane acrylate as claimed in claim 1, wherein the polyisocyanate is a triisocyanate.

5. The urethane acrylate as claimed in claim 4, wherein the molar ratio of α,ω-polymethacrylatediol to triisocyanate to hydroxyalkyl acrylate is about 1:2:4.

6. The urethane acrylate as claimed claim 1, wherein the hydroxyalkyl acrylate is a hydroxy-functional triacrylate.

7. A urethane acrylate, obtainable by reacting
a) α,ω-polymethacrylatediols, mixtures thereof or mixtures of polyols and α,ω-polymethacrylatediols with
b) one or more isocyanate-functional acrylates or methacrylates in the presence of
d) inhibitors and, optionally,
e) isocyanate-reactive compounds.

8. The urethane acrylate as claimed in claim 7, wherein the molar ratio of α,ω-polymethacrylatediol to isocyanate-functional (meth)acrylate is about 1:1.

9. The urethane acrylate as claimed in claim 1, wherein the polyols are polyesterpolyols, polyetherpolyols, polycarbonatediols or monomeric polyols.

10. The urethane acrylate as claimed in claim 7, wherein wherein the polyols are polyesterpolyols, polyetherpolyols, polycarbonatediols or monomeric polyols.

11. A process for preparing a urethane acrylate, which comprises reacting
a) α,ω-polymethacrylatediols, mixtures thereof or mixtures of polyols and α,ω-polymethacrylatediols with
b) one or more polyisocyanates containing in each case at least two isocyanate groups and
c) one or more hydroxyalkyl acrylates or hydroxyalkyl methacrylates in the presence of
d) inhibitors and, optionally,
e) isocyanate-reactive compounds.

12. A process for preparing a urethane acrylate, which comprises reacting
a) α,ω-polymethacrylatediols, mixtures thereof or mixtures of polyols and α,ω-polymethacrylatediols with
b) one or more isocyanate-functional acrylates or methacrylates in the presence of
d) inhibitors and, optionally,
e) isocyanate-reactive compounds.

13. The process as claimed in claim 11, wherein the resulting urethane acrylate is emulsified in water using one or more emulsifiers.

14. The process as claimed in claim 12, wherein the resulting urethane acrylate is emulsified in water using one or more emulsifiers.

15. A coating composition which comprises a urethane acrylate as claimed in claim 1 and, optionally, an additive.

16. The coating composition as claimed in claim 15, wherein the additive is a monomer selected from monofunctional or polyfunctional acrylates, a photoinitiator, a photosensitizer, an oligomer, a filler, a flatting agent, a thickener, a reactive diluent, a pigment, a solvent, and a light stabilizer.

17. A method for increasing the resistance of a substitute to scratch and wear which comprises applying the coating composition as claimed in claim 15 to said substrate.

18. A coating composition which comprises an urethane acrylate as claimed in claim 7 and, optionally, an additive.

19. The coating composition as claimed in claim 18, wherein the additive is a monomer selected from monofunctional or polyfunctional acrylates, a photoinitiator, a photosensitizer, an oligomer, a filler, a flatting agent, a thickener, a reactive diluent, a pigment, a solvent, and a light stabilizer.

20. A method for increasing the resistance of a substrate to scratch and wear which comprises applying the coating composition as claimed in claim 18.

21. An article which is coated with a coating composition according to claim 15.

22. An article which is coated with a coating composition according to claim 18.

23. A urethane acrylate of the formula 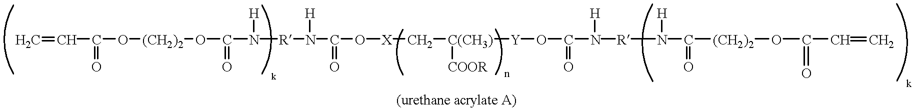
wherein
R is alkyl
R′ is alkyl, an aromatic group, or a condensate or adduct of isocyanates;
n is an integer from 2 to 1000; and
k is an integer from l to 5.

24. The urethane acrylate according to claim 23, wherein
R is a C₁-C₂₀ alkyl group,
R′ is a C₁-C₂₀ alkyl group, a C₁-C₂₀ aromatic group, uretdione, isocyanurate, iminoxadiazimedione, biuret, urethane, allophanate.

25. A coating composition which comprises a urethane acrylate according to claim 23 and, optionally, an additive.

26. An article which is coated with a coating composition according to claim 23.

27. A method for increasing the resistance of a substrate to scratch and wear which comprises applying the coating composition according to claim 25 to the substrate.

28. A urethane acrylate of the formula 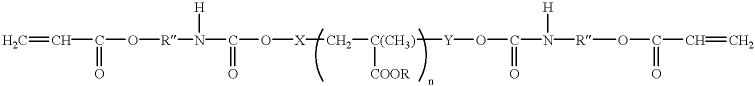
wherein
R is alkyl,
R″ is alkyl and
n is an integer from 2 to 1000.

29. The urethane acrylate according to claim 28 wherein R is C₁-C₂₀ alkyl and R″ is C₁-C₈ alkyl.

30. A coating composition which comprises a urethane acrylate according to claim 28 and, optionally, an additive.

31. An article which is coated with a coating composition according to claim 30.

32. A method for increasing the resistance of a substrate to scratch and wear which comprises the coating composition according to claim 30 to the substrate.
